(19) United States
(12) Patent Application Publication
(10) Pub. No.: US 2006/0161464 A1
(43) Pub. Date: Jul. 20, 2006

(54) Method and system for web-based organizational reporting management

(76) Inventor: Joseph S. Green, Washington, DC (US)

Correspondence Address: ARENT FOX PLLC, 1050 CONNECTICUT AVENUE, N.W., SUITE 400, WASHINGTON, DC, 20036, US

(21) Appl. No.: 11/268,724

(22) Filed: Nov. 8, 2005

Related U.S. Application Data
(60) Provisional application No. 60/625,944, filed on Nov. 9, 2004.

(51) Int. Cl. G06F 9/44

(52) U.S. Cl. 705/7

(57) ABSTRACT

A method and system that include a number of functionally and interactively integrated components for assistance with recording services provided to a number of individuals by various organizations. The organizations include, for example, those providing social services, educational assessments, training, job placement, or other services to individuals. In one variation, a web-based system is accessed by employees of the organizations. The web-based system includes several functions accessible by the employees to monitor services provided to the individuals, and also includes one or more data repositories (e.g., databases) associated with the functions, which allow entry and interrelation of data. The functions are directed to activities relating to provision of services.

### BACKGROUND OF THE INVENTION

1. Field of the Invention

The present invention relates to a software based method and system for tracking services provided to individuals, and in particular to a software based method and system for tracking social services, training, and job placement, and for using data provided in such determinations for such purposes as creating reports or tracking the progress of individuals.

2. Background of the Technology

There is an unmet need in the art for methods and systems for the tracking of the complex and sophisticated management schemes that institutions need to use in order to effectively and efficiently manage social services, training, and job placement for hundreds if not thousands of individuals simultaneously. The problem of managing such services is complicated by the fact that such services have different start and end dates and different internal individualized management steps. For example, looking at social services non-profit institutions, it is not uncommon to find that such an institution may need to manage a large number of individuals while providing meal plans, child care, job training, educational assessment, and job placement. Each of these programs consists of requirements involving events or meetings (such as a training session or follow-up meeting or telephone call), associated timelines, linked paperwork, and mandated outcomes. Successful, consistent execution of these programs requires the coordination of various steps for each program. Failure to effectively manage such programs significantly diminishes the effectiveness of these programs, risks loss of grant funding or other funding, and drives up administrative overhead.

The desire to coordinate various services points to the need for a software-based method and system for planning, tracking, and reporting the outcome of various programs.

### SUMMARY OF THE INVENTION

The present invention includes an application to allow organizations providing services to at-risk populations or to membership groups to document, track, and report services provided to individuals in an efficient web-based environment.

The present invention, referred to in one embodiment as “Web-based Organizational Reporting Management System” or “WORMS,” provides a database structure and platform that embodies an effective method and system for maintaining records of individuals receiving services, maintaining records of services received, tracking upcoming events associated with the services, and generating reports using the information stored in the system.

One embodiment of the present invention provides a method and system that include a number of functionally and interactively integrated components for assistance with recording services provided to a number of individuals by various organizations. The organizations are, for example, organizations providing social services, educational assessments, training, job placement, or other services to individuals. In one embodiment, the invention includes a web-based system that is accessed by employees of the organizations. The web-based system includes several functions accessible by the employees to monitor services provided to the individuals, and also includes one or more data repositories (e.g., databases) associated with the functions, which allow entry and interrelation of data. The functions are directed to activities relating to provision of services.

The system of one embodiment of the present invention includes a graphical user interface (GUI) for input and other interaction by those accessing the system. In one embodiment, the GUI includes a visual representation of the various parts of the entered data and offered services, so as to provide tailored prompting and other assistance to a user.

In an embodiment of the present invention, data, including preloaded data and data that is stored from user and/or other input, is accessible via a network, such as the Internet, using a client terminal, such as a personal computer (PC) coupled to the network.

Features and functions of a particular embodiment of the present invention will now be described in greater detail.

Implementation

In one embodiment, the system is installed at a host site with one or more customers accessing over a network, such as the Internet. In a hosted or Active Service Page (ASP) model, one customer may not have access to another customer's data. Further security may exist which sequesters the data from one organization from that of another organization.

Drop-down menus specifying types of services provided by an organization, such as drop-down menus including names of courses, names of assessments, and names of providers, can be configured by an organization using a simple easy user interface. Multiple simultaneous configurations can exist such that multiple organizations can use the same hardware.

Users

Users of the system have password-protected access and controlled data access privileges or other security features based, for example, on user roles. In one implementation, all user access to individual data, and the reason for access is recorded. A first user type is an employee of an organization. Such a user may access data for that particular organization, enter data for that organization, and generate reports using the data for that organization. Such a user may also alter drop-down menus and access other administrative functions to tailor the system to the particular needs of the organization.

A second user type is an employee of a partner organization. For example, a first organization may partner with a second organization to provide particular services to certain individuals. In this case, the first organization may be provided with a partner identification (ID) and a partner password that allow selective access to the data of the second organization. For example; the partner ID and partner password allow employees of the first employee to access the report page of the second organization and to run reports using the data of the second organization. A partner ID and a partner password typically do not allow a user to input data for another organization.

A third user type is a system administrator. Such a user defines global variables, adds other users to the system, and performs maintenance on the system.

Functions

In one implementation, the invention provides various functions for entering and managing service data. The functions included in the present invention are, for example, Search, Application, Placement, Training, Services, Tracking, Reports, and Administration.

Search

The Search function allows a user of the system to search for data concerning a particular individual. Once a search has been performed, the user can access, enter, edit, and view data for the individual, including personal data and data concerning the services provided to the individual.

The search function allows a user to search for an individual, for example, by state, city, demographic profile, education level, employment status, name, or social security number. When the data for the individual is located in the system, the user is provided with, for example, an indication of whether the individual's application is complete, the services that have been provided to the individual, and the courses that have been provided to the individual. A user who is an employee of a particular organization may view data only for that organization.

Application

The Application function allows a user of the system to enter, edit, and view data concerning an individual who is applying for services at an organization.

When an individual wishes to enroll for services at an organization as a new applicant, a user may log into the system and select “Application.” The user then enters relevant information for the individual, including, for example, name, social security number, birthdate, address, and telephone number.

The system then performs a background check, for example, based on the name and social security number. The background check compares the entered data to other data in the system to ensure that the individual does not already exist in the system. In one implementation, the background check compares the name and social security number for the individual against the data in the system for all other organizations, but does not perform an external check. This ensures that duplicates are not input into the system, which preserves the integrity of the data and protects against identity theft.

If an individual with the same name and/or social security number already exists in the system, the user will be informed and will be asked to select whether this is a duplicate entry. If the user determines that the individual applying for services is different from the individual already in the system, the user clicks “no,” is presented with the option of editing the data, and is allowed to proceed.

If the user determines that the individual applying for services is the same as the individual already in the system, the user clicks “yes.” The user may then determine whether the individual is eligible to receive the desired services. For example, if the system informs the user that the individual is receiving a job placement service from Salvation Army, the user may not be eligible to receive a job placement service from Goodwill. However, if the system informs the user that the individual is receiving meal services, the individual may be eligible to receive childcare. If the user determines that the individual is eligible to receive services, the user proceeds, and information entered will be associated with the information already in the system.

The system tailors the data input screens to the data that has already been entered in the system. For example, if a user enters data for an individual who is between the ages of 18-21, the user will be presented with a youth screen with youth-specific data entry fields. If a user selects that an individual has dependents, the user will be presented with a dependents screen, and if a user selects that an individual is a veteran, the user will be presented with a veteran's screen. Similar screens are presented to the user if the user enters selects that the individual has a disability, a criminal record, or the like. The user also enters, for example, data relating to education, employment (e.g., job type), employment status, past employment, skills, languages, medications, and emergency contacts.

The user can also enter, for example, the results of assessments taken by the individual. For example, if the user selects “Education assessment,” the user is prompted to enter the location of the assessment (for example, Salvation Army), the type of test (for example, Microsoft Excel proficiency) and the results of the test (for example, pass). If, for example, Salvation Army is entered as the location for the assessment, that entity is linked as a partner for the particular individual, because that entity provided a service to the individual.

Placement

The Placement function allows a user of the system to enter, edit, and view data concerning job placement for a particular individual.

Once an individual has been placed in a job, the user may enter information concerning placement. Information entered includes, for example, salary, location, start date, end date, and commitment (such as 35 hours/week). The user may also enter tracking information, which describes a tracking schedule. The tracking schedule is the schedule for the organization to monitor the individual's progress, such as, for example, once a week for 8 weeks. An organizational user will be notified to check the individual's progress. The entered data also includes, for example, contact information for the person, such as the Human Resources manager, to be contacted in tracking the individual's progress.

Other data entered for a job placement includes any relevant skills information. For example, the user may enter whether the individual was trained in a particular skill, and whether the individual was subsequently placed in that skill.

Training

The Training function allows a user of the system to enter, edit, and view data concerning training for a particular individual.

Data entered for training is similar to the data entered for placement. The user may select the individual, and enter data for the training course, including the course provider, the course, employment information, the start date of the course, the end date of the course, the commitment (such as, for example, 4 hrs/week), and tracking information (for example, indicating the individual should be checked on daily for 10 days), and the individual's goal (for example, “I want to be a certified chef”).

Services

The Services function allows a user of the system to enter, edit, and view data concerning services provided to a particular individual.

Data entered for services is similar to the data entered for placement or for training. The user may select the individual, and enter data for the service, including the service provider, the service, employment information, the start date of the service, the end date of the service, the commitment (such as 4 hrs/week), and tracking information (for example, indicating the individual should be checked on daily for 10 days), and the individual's goal (for example, “I want to receive transportation”).

Tracking

The Tracking function allows a user of the system to enter, edit, and view data concerning upcoming meetings or tracking requirements. Tracking data is entered, for example, in connection with placement, training, or services. A user of the system is alerted that tracking should occur and is presented with relevant information for the individual, the placement, training, or service, and contact information.

Reports

The Reports function allows a user of the system to generated reports based on data entered into the system.

Various reports can be generated. For example, a tracking period report shows all intake (new applicants) for a selected time period. From the tracking period report, a user can select the applicant to be presented with the training, placement, and other services to be received. Once a report has been created, it can be sorted by various criteria. For example, a tracking period report can be sorted by ethnic group and by location.

Other reports include placement event reports, service event reports, training event reports, and tracking event reports, which track upcoming tracking events and list the events sorted by individual. The system also provides for applicant record reports, which report on all services provided for a particular individual.

The system also provides for a partner ID and partner password that allow members of a partner institution to access a report page of another institution. For example, if Ruth's Place has sent a number of individuals to a particular training center for training, Ruth's Place may be interested in the progress of those individuals. In this case, the training center can run a report that tracks the training of people with referral of “Ruth's Place,” and can then provide this report to Ruth's Place. Alternatively, the training center can provide Ruth's Place with a partner ID and partner password. This allows users with the Partner ID and partner password to access the Reporting function for the training center, and Ruth's Place can then run reports using the training center's data.

Administration

The Administration function allows a user of the system to tailor the system to the needs of a particular organization.

The administration function allows a user, for example, to edit drop-down menus to include choices specific to an organization, such as names of courses, names of assessments, and names of providers.

System Administration

The invention provides for a system administration function, which allows a system administrator to add new organizations, services, programs, placements, assessments, courses, offices, and the like. The system administration function also allows a system administrator to determine access to various screens and data, to add users, to move individuals to various organizations, and to grant report-level access to another partner's data.

Suggestion Box and Help Screens

The invention also provides a suggestion box that allows users can report errors, make recommendations, etc. The invention further includes help screens that provide users with assistance.

Additional advantages and novel features of the invention will be set forth in part in the description that follows, and in part will become more apparent to those skilled in the art upon examination of the following or upon learning by practice of the invention.

### BRIEF DESCRIPTION OF THE FIGURES

In the drawings:

FIG. 1 presents an exemplary system diagram of various hardware components and other features in accordance with an embodiment of the present invention;

FIG. 2 shows an exemplary computer system usable with embodiments of the present invention;

FIG. 3 contains an exemplary graphical user interface (GUI) screen for use in accordance with an embodiment of the present invention;

FIGS. 4A and 4B show exemplary system modules, in accordance with an embodiment of the present invention; and

FIG. 5 presents an exemplary parent organization chart for a sample organization for which embodiments of the present invention are usable.

### DETAILED DESCRIPTION

The present invention provides a state-of-the art web-based or other network business solution for public and private providers of placement, training and other support services to at-risk and membership populations. The present invention is suited for the following objectives:
1) Managing large-scale programs providing social services to at-risk populations where outcomes results are required, including employment and training services, counseling and mentoring, housing, health and health-related, as well as support services such as Childcare, transportation, etc.
1) Umbrella organizations providing collaboration and coordination of member services, where virtual collaboration meets a critical member objective while maintaining a wall of confidentiality at the local level.
3) Stand-alone organizations providing services to at-risk and other populations that want the power and confidence of a multi-million dollar program management system, but not want to invest and maintain the technical resources to support it.

In one exemplary embodiment, the present invention includes several valuable features, including the following:
Gold-Standard Service. Gold-standard service is provided to clients across organization units and partners, with delivery and outcomes proactively managed and tracked. Increased staff productivity and efficiency is provided through wider distribution of work effort, with services securely delivered anywhere/anytime, at click-and-go speed, in a user friendly environment.
Solid Program Support. Key evaluator and manager support is maximized through 24×7 visibility of program accomplishments and progress. The attention of civic leaders and philanthropists is captured with polished reports of program success.
Improved Financial Position. The invention supports development of winning grant proposals through unparalleled documentation, tracking and reporting capability—current and proposed. Costs of Database Administrator, Web-Master, System Administrator, Hardware and Software, Help Desk and more are transferred out of the organization.
   The present invention includes large scale data management features, including the following:
1) Standardized definitions of data for geographically dispersed organizations support, consistent program and organization outcomes reporting.
2) Local data management distributes workload of data entry and maintenance across participating organizations.
3) Central data collection enables real-time reporting of program achievements across organization(s) to support strategic management and grant development efforts.
4) Click-and-go data entry speeds up applicant profiling, with minimal typing and errors; ensures data consistency.
5) Data is secure, with firewalls against external intruders, posted “guards” against internal data corruption, and daily back-up of data in the unlikely event of system failure (in over two years of operation the system has yet to experience a system of failure)

The present invention allows robust and flexible reporting, embodiments of which include the following features:
1) Polished standard reports in print-and-present format that make great fact sheets.
2) High-level program data or drill-down into details can be included in reports.
3) Reports maintain confidentiality of data, with high-security users able to view detailed reports, and lower-security users only able to view aggregate-level reports.
4) Program results available anywhere, anytime

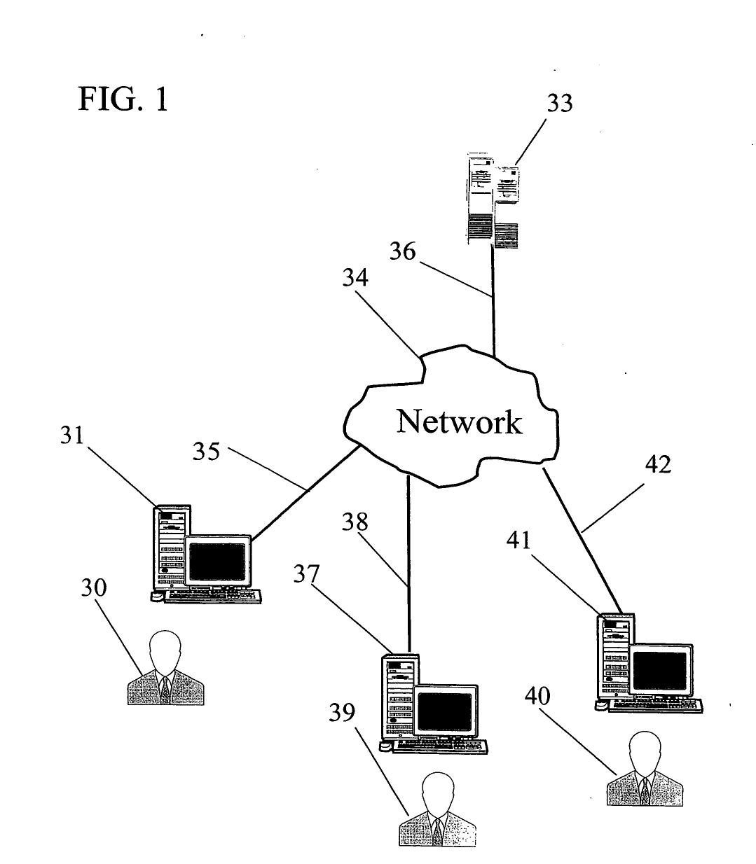

FIG. 1 presents an exemplary system diagram of various hardware components and other features in accordance with an embodiment of the present invention. As shown in FIG. 1, in an embodiment of the present invention, data and other information and services for use in the system is, for example, input by an end user 30 via a terminal 31. The terminal 31 is coupled to a server 33 via a network 34, such as the Internet, via couplings 35, 36. In one embodiment, a system administrator 39 also inputs information/data via a terminal 37 coupled 38 to the network 34. Furthermore, in one embodiment, a user 40 with a partner ID and partner password accesses information/data via a terminal 41 coupled 42 to the network 34.

Each of the terminals 31, 37, 41, is, for example, a personal computer (PC), minicomputer, mainframe computer, microcomputer, telephone device, personal digital assistant (PDA), or other device having a processor and input capability. The terminal 31 is coupled to a server 33, such as a PC, minicomputer, mainframe computer, microcomputer, or other device having a processor and a repository for data or connection to a repository for maintained data. In operation, in an embodiment of the present invention, via the network 34, data and/or other information is communicated with the server 33. The server 33, for example, stores data.

In one embodiment, the present invention uses active server page (ASP) technology to deliver information and services to a user. This may include one or more ASPs stored on the server 33. Use of this technology reduces the maintenance expense and hardware expense, results in limited implementation/integration costs, limited support expenses, and low total cost of ownership.

In one embodiment of the present invention, information relating to provided services is stored electronically.

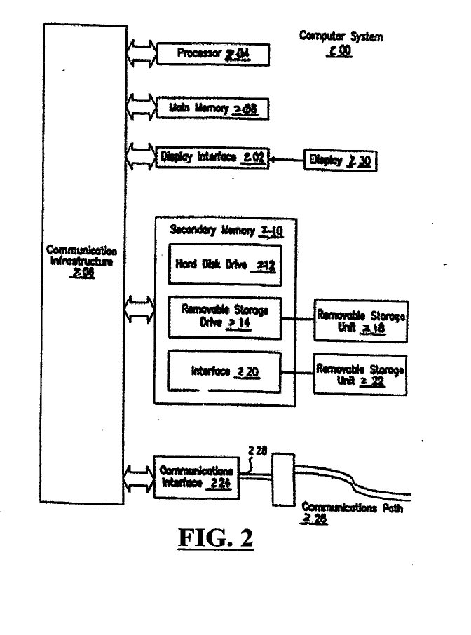

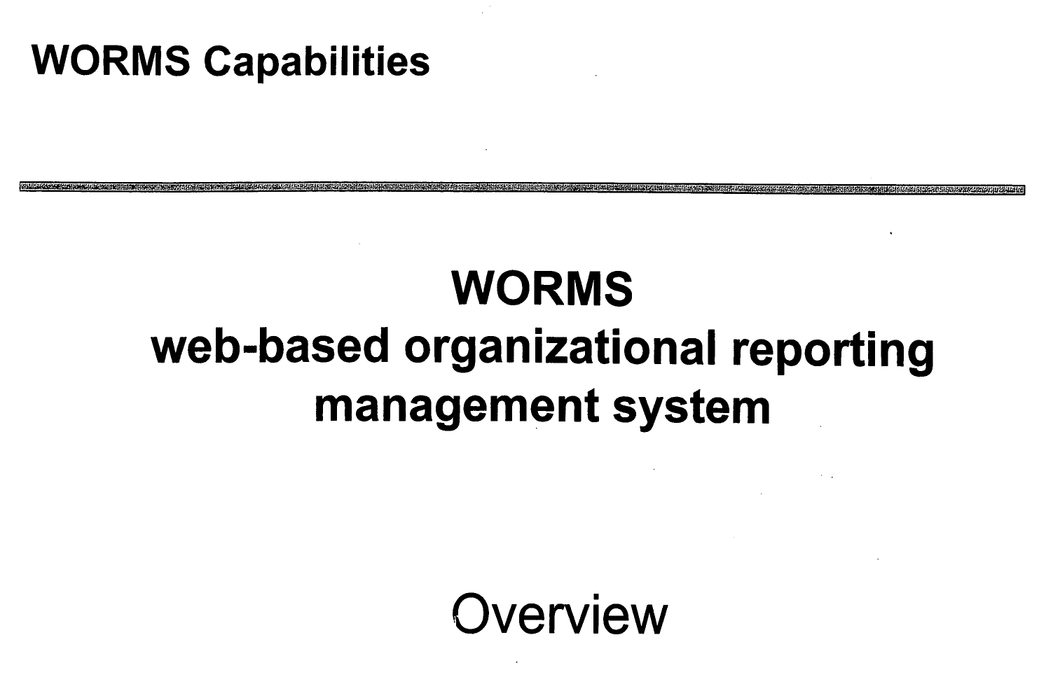

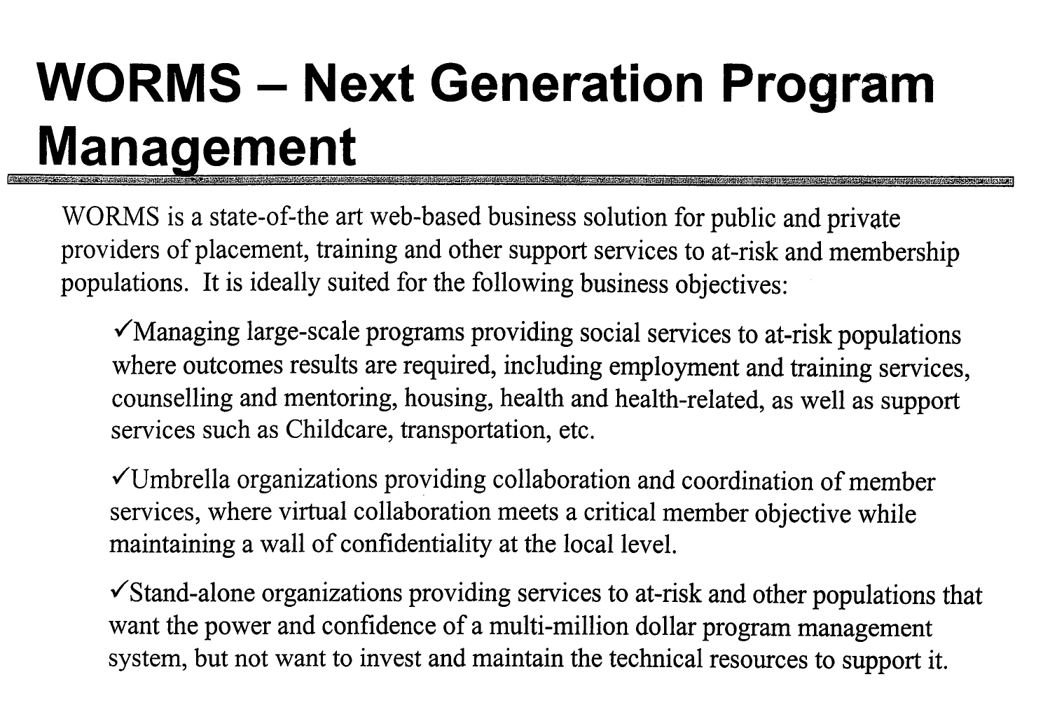

The present invention may be implemented using hardware, software or a combination thereof and may be implemented in one or more computer systems or other processing systems. In one embodiment, the invention is directed toward one or more computer systems capable of carrying out the functionality described herein. An example of such a computer system 200 is shown in FIG. 2.

Computer system 200 includes one or more processors, such as processor 204. The processor 204 is connected to a communication infrastructure 206 (e.g., a communications bus, cross-over bar, or network). Various software embodiments are described in terms of this exemplary computer system. After reading this description, it will become apparent to a person skilled in the relevant art(s) how to implement the invention using other computer systems and/or architectures.

Computer system 200 can include a display interface 202 that forwards graphics, text, and other data from the communication infrastructure 206 (or from a frame buffer not shown) for display on the display unit 230. Computer system 200 also includes a main memory 208, preferably random access memory (RAM), and may also include a secondary memory 210. The secondary memory 210 may include, for example, a hard disk drive 212 and/or a removable storage drive 214, representing a floppy disk drive, a magnetic tape drive, an optical disk drive, etc. The removable storage drive 214 reads from and/or writes to a removable storage unit 218 in a well-known manner. Removable storage unit 218, represents a floppy disk, magnetic tape, optical disk, etc., which is read by and written to removable storage drive 214. As will be appreciated, the removable storage unit 218 includes a computer usable storage medium having stored therein computer software and/or data.

In alternative embodiments, secondary memory 210 may include other similar devices for allowing computer programs or other instructions to be loaded into computer system 200. Such devices may include, for example, a removable storage unit 222 and an interface 220. Examples of such may include a program cartridge and cartridge interface (such as that found in video game devices), a removable memory chip (such as an erasable programmable read only memory (EPROM), or programmable read only memory (PROM)) and associated socket, and other removable storage units 222 and interfaces 220, which allow software and data to be transferred from the removable storage unit 222 to computer system 200.

Computer system 200 may also include a communications interface 224. Communications interface 224 allows software and data to be transferred between computer system 200 and external devices. Examples of communications interface 224 may include a modem, a network interface (such as an Ethernet card), a communications port, a Personal Computer Memory Card International Association (PCMCIA) slot and card, etc. Software and data transferred via communications interface 224 are in the form of signals 228, which may be electronic, electromagnetic, optical or other signals capable of being received by communications interface 224. These signals 228 are provided to communications interface 224 via a communications path (e.g., channel) 226. This path 226 carries signals 228 and may be implemented using wire or cable, fiber optics, a telephone line, a cellular link, a radio frequency (RF) link and/or other communications channels. In this document, the terms “computer program medium” and “computer usable medium” are used to refer generally to media such as a removable storage drive 214, a hard disk installed in hard disk drive 212, and signals 228. These computer program products provide software to the computer system 200. The invention is directed to such computer program products.

Computer programs (also referred to as computer control logic) are stored in main memory 208 and/or secondary memory 210. Computer programs may also be received via communications interface 224. Such computer programs, when executed, enable the computer system 200 to perform the features of the present invention, as discussed herein. In particular, the computer programs, when executed, enable the processor 204 to perform the features of the present invention. Accordingly, such computer programs represent controllers of the computer system 200.

In an embodiment where the invention is implemented using software, the software may be stored in a computer program product and loaded into computer system 200 using removable storage drive 214, hard drive 212, or communications interface 224. The control logic (software), when executed by the processor 204, causes the processor 204 to perform the functions of the invention as described herein. In another embodiment, the invention is implemented primarily in hardware using, for example, hardware components, such as application specific integrated circuits (ASICs). Implementation of the hardware state machine so as to perform the functions described herein will be apparent to persons skilled in the relevant art(s).

In yet another embodiment, the invention is implemented using a combination of both hardware and software.

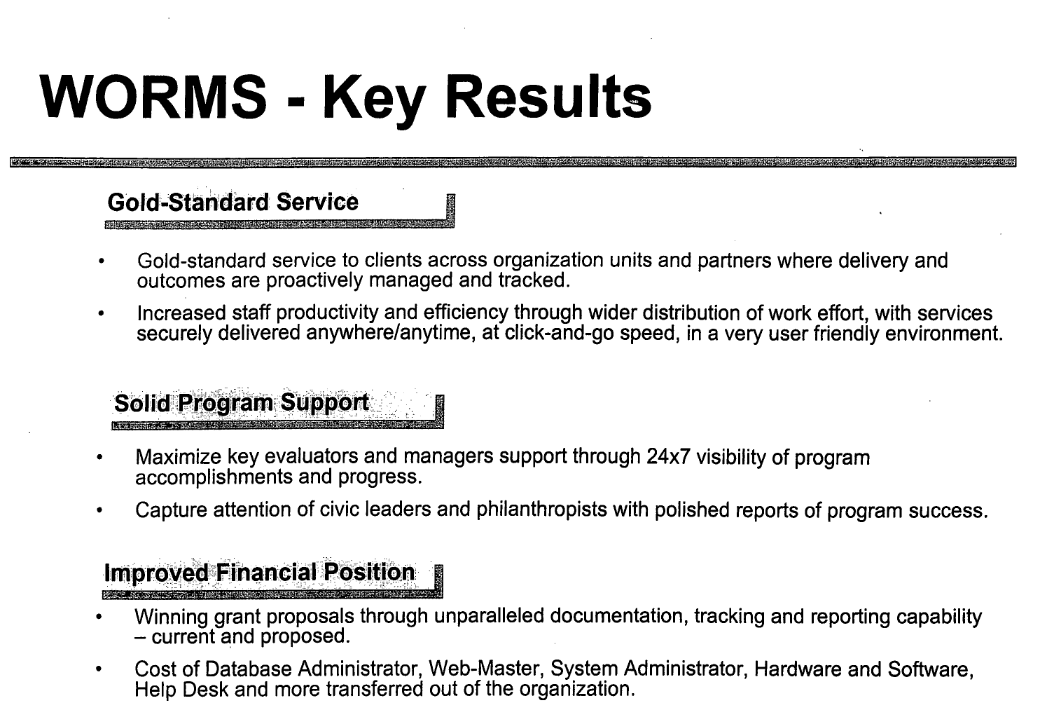

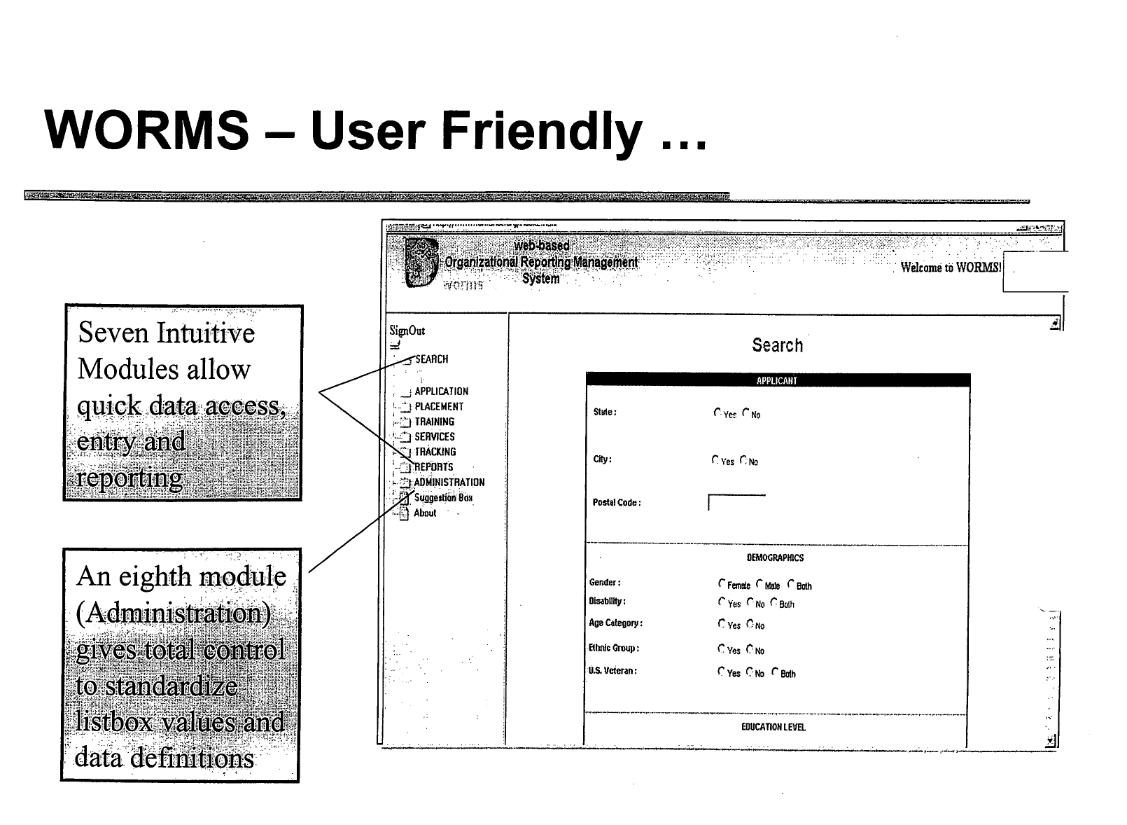

FIG. 3 contains an exemplary graphical user interface (GUI) screen for use in accordance with an embodiment of the present invention.

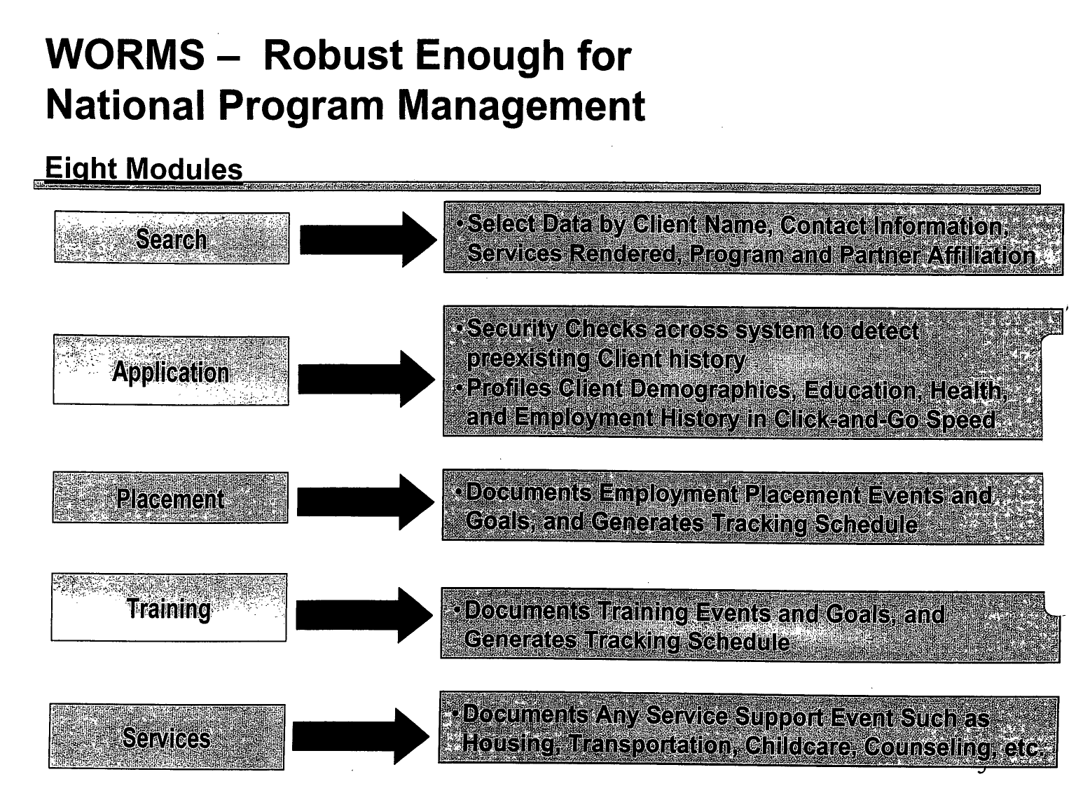

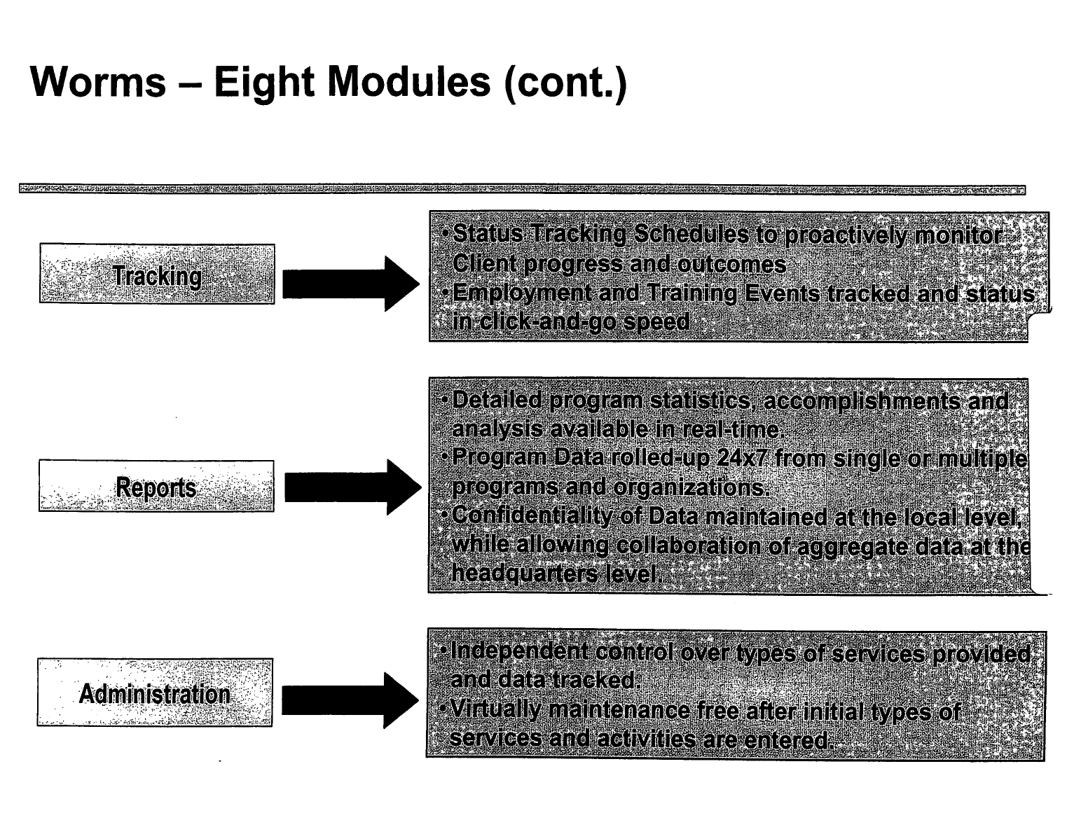

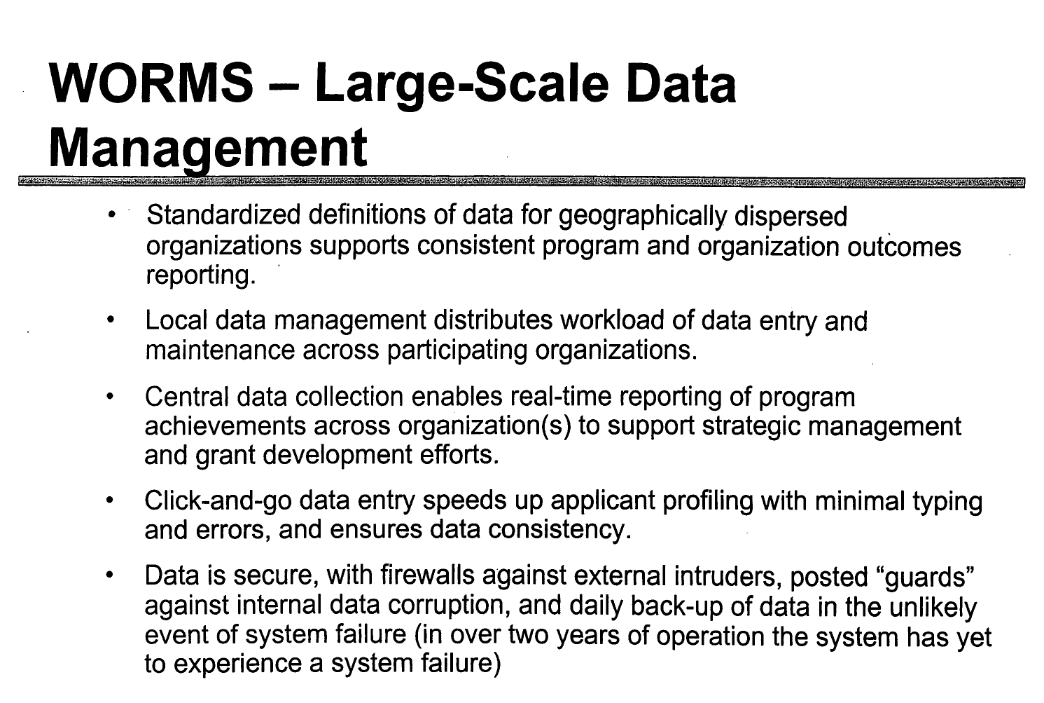

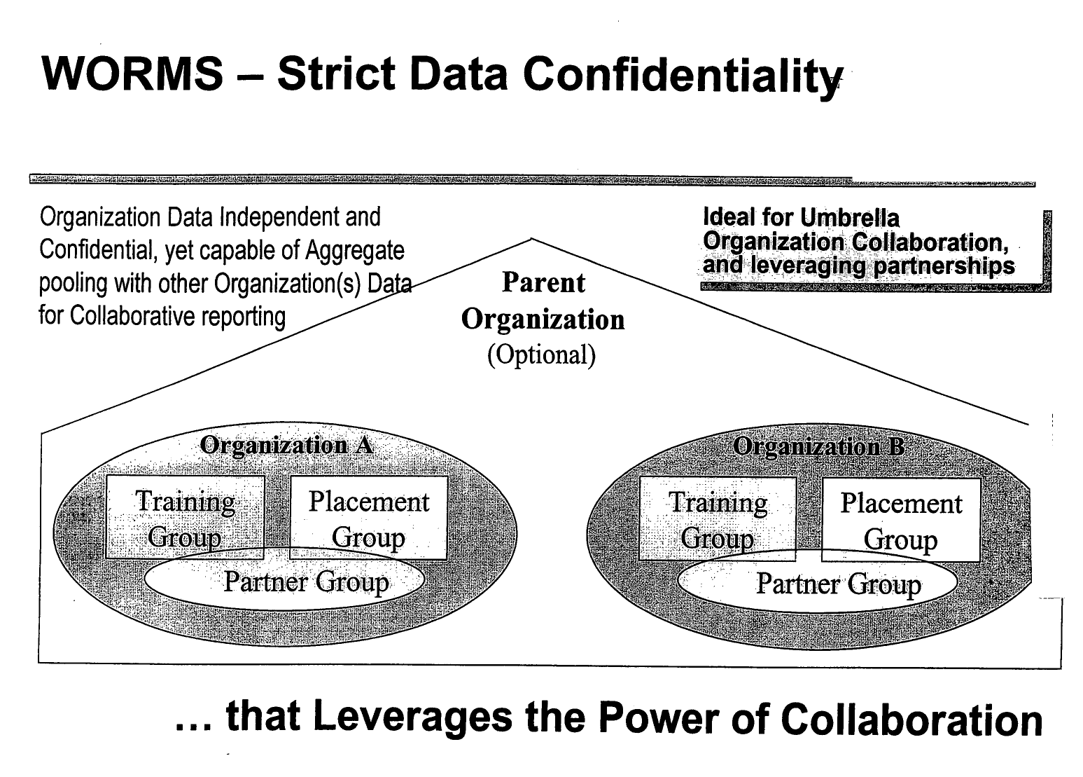

FIGS. 4A and 4B show exemplary system modules, in accordance with an embodiment of the present invention.

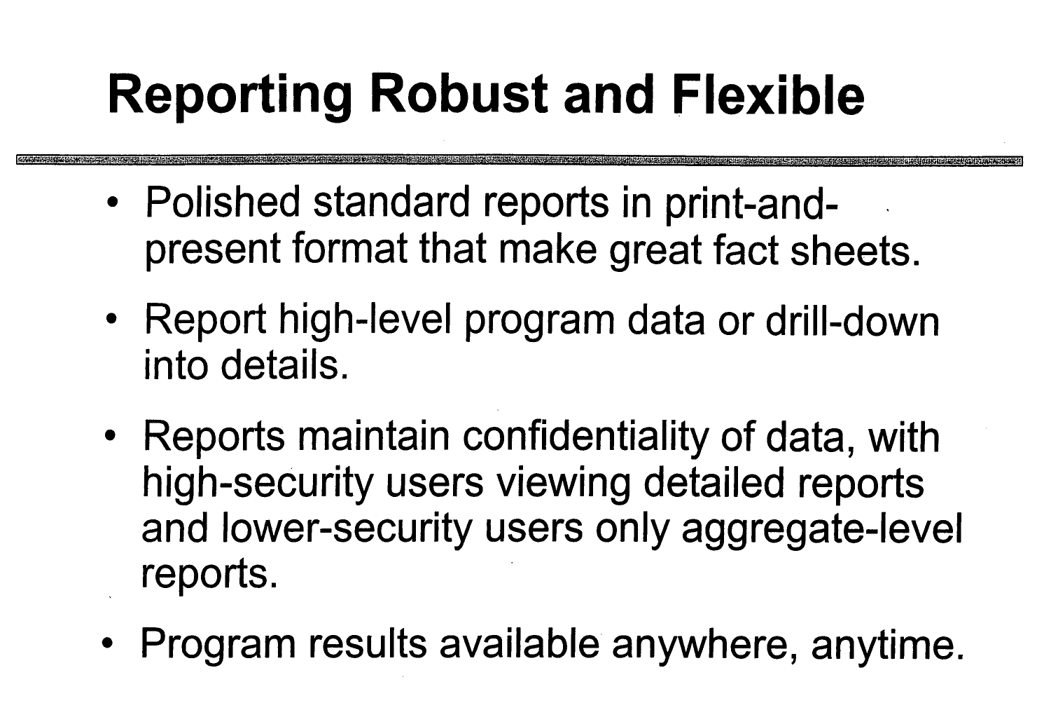

FIG. 5 presents an exemplary parent organization chart for a sample organization for which embodiments of the present invention are usable.

Example embodiments of the present invention have now been described in accordance with the above advantages. It will be appreciated that these examples are merely illustrative of the invention. Many variations and modifications will be apparent to those skilled in the art.

We claim:

1. A method for tracking services provided to individuals, comprising:
receiving records of services provided to individuals;
maintaining the records at a database;
tracking events associated with the services provided to the individuals; and
generating a report based on the records stored at the database.
